(19) United States
(12) Patent Application Publication
(10) Pub. No.: US 2016/0065539 A1
(43) Pub. Date: Mar. 3, 2016

(54) METHOD OF SENDING INFORMATION ABOUT A USER

(71) Applicant: CEQUITY LLC, Spring Valley, NY (US)

(72) Inventor: Yakov Z. MERMELSTEIN, Spring Valley, NY (US)

(73) Assignee: CEQUITY LLC, Spring Lane, NY (US)

(21) Appl. No.: 14/843,234

(22) Filed: Sep. 2, 2015

Related U.S. Application Data
(60) Provisional application No. 62/044,425, filed on Sep. 2, 2014.
(60) Provisional application No. 62/052,024, filed on Sep. 18, 2014.

(51) Int. Cl. H04L 29/06; G06F 17/30

(52) U.S. Cl. CPC H04L 63/04; H04L 63/12; H04L 63/0861; G06F 17/30312; G06F 17/30377

(57) ABSTRACT

The invention involves detecting or scanning of a personal characteristic of a user and then verifying the person's identity by means of that physical characteristic. If the identity is confirmed, then information is disclosed, as required. In the preferred embodiment, the method of sending information about a user includes the steps of: an entity issuing an electronic identifier; detecting a personal characteristic of a user; confirming an identity of said user by means of the personal characteristic; and sending a secure electronic transmission relating to the electronic identifier to the entity with information pertaining to that user.

### CROSS-REFERENCE TO RELATED APPLICATIONS

This application claims the benefit of U.S. Provisional No. 62/044,425, filed Sep. 2, 2014, and U.S. Provisional No. 62/052,024, filed Sep. 18, 2014, which are incorporated herein by reference in their entireties.

### FIELD OF THE DISCLOSURE

This invention relates to the electronics and communications industry and, more particularly, to an electronic method of distributing information, based on verification of a person's identity, as well as to the electronics and communications industry and, more particularly, to the field of Artificial Intelligence for providing responses to audio, written or physical statements.

### BACKGROUND OF THE DISCLOSURE

One of the key problems in today's fast moving society is the fast transmission of information. People need information, and they need it quickly.

Whether it is entering a store or entering an Internet website, there is an important need to get information delivered fast, so transactions can be conducted quickly and efficiently.

A person may enter a bank or a department store or a utilities office or a government office, and the issue is the same. Information on the client or customer is needed. The current way is a person waits until he is seen by an agent or representative. Then, a name or ID number is entered and the clerk waits for his computer screen to bring up the data.

This process is filled with a lot of problems. The first is one of security. How does the clerk or representative actually know the person is who he says he is? A perfunctory look at a picture ID really is not always effective.

Another time consuming issue is entry of secure websites. They always ask for user name and password, but fraud can still be involved. Even if a valid user name and password is entered, how does the proprietor of the secure website actually know it really is the right person?

Therefore, there is a need in the industry for a fast efficient way to verify a person's identity so that information can be disclosed quickly.

Artificial intelligence (AI) is the intelligence exhibited by machines or software. The central goals of AI research include reasoning, knowledge, planning, and learning, natural language processing (communication), perception and the ability to move and manipulate objects. General intelligence is still among the field's long term goals. There are a large number of tools used in AI, including versions of search and mathematical optimization, logic, methods based on probability and economics, and many others. The AI field is interdisciplinary, in which a number of sciences and professions converge, including computer science, psychology, linguistics, philosophy and neuroscience, as well as other specialized field such as artificial psychology.

NLP (Natural Language Processing) is a form of artificial intelligence. It involves the interactions between computers and human (natural) languages. The purpose of NLP is to enable computers to derive meaning from human or natural language input and to then act, based on the natural language input.

Modern NLP algorithms are based on machine learning. The paradigm of machine learning is different from that of most prior attempts at language processing. Prior implementations of language-processing tasks typically involved the direct hand coding of large sets of rules. The machine-learning paradigm calls instead for using general learning algorithms to automatically learn such rules through the analysis of large corpora of typical real-world examples. A corpus (plural, “corpora”) is a set of documents (or sometimes, individual sentences) that have been hand-annotated with the correct values to be learned.

Many different classes of machine learning algorithms have been applied to NLP tasks. These algorithms take as input a large set of “features” that are generated from the input data. Some of the earliest-used algorithms, such as decision trees, produced systems of hard if-then rules similar to the systems of hand-written rules that were then common. Increasingly, however, research has focused on statistical models, which make soft, probabilistic decisions based on attaching real-valued weights to each input feature. Such models have the advantage that they can express the relative certainty of many different possible answers rather than only one, producing more reliable results when such a model is included as a component of a larger system.

Generally NLP is at the point where a computer (software) can respond to a natural language (NL) command or instruction. The NL instruction may be “What is the weather today,” and the NLP system can understand and process that instruction and provide information on the weather. Another example would be “How high is the Empire State Building,” and it researches and provides the answer. In other words, the current utilizations of NLP operate in response to the specific NL statement/command.

Gruber (Apple, Inc.) (EP2575128) teaches that the computer system responds to the specific NL command. For example, the user may provide input to assistant 1002 such as “I need to wake tomorrow at 8 am”. Once assistant 1002 has determined the user's intent, using the techniques described herein, assistant 1002 can call external services 1340 to interface with an alarm clock function or application on the device. (Paragraph 76)

Boyle (IBM) (U.S. Published Patent application 2012/0303356) discloses a method for providing information to a user in response to a received user query. This is the classic use of NLP. A question in NL is answered by the system. The query analysis ascertains whether the user query is more suitable for service than for a search for information. If it is ascertained by the query analysis that the user query is more suitable for service than for a search for information, then service actions to be performed by the user are identified to the user. (Paragraph 71)

Luciw (Apple, Inc.) (U.S. Pat. No. 5,608,624) discloses a method and apparatus for processing natural language and deducing meaning from a natural language input characterized by the steps of (a) receiving an ordered string of word objects having a natural language meaning, (b) selecting a word window length, and (c) successively moving the word window along the ordered string and analyzing the meaning of a substring of word objects that fall within the word window. The meaning of the substring is analyzed by mapping the substring against a database using one or more mapping routines. The mapping routines are preferably arranged in a hierarchy, wherein a successive mapping routine is used to analyze the substring when a previous mapping routine in the hierarchy cannot map the substring.

Julia (SRI International) (U.S. Pat. No. 6,513,063) discloses a system, method, and article of manufacture for navigating an electronic data source that has a scripted online interface by means of spoken input. When a spoken request is received from a user, it is interpreted. A navigation query is constructed based on the interpretation of the speech input and a template extracted by scraping an online scripted interface to the data source. The resulting interpretation of the request is thereupon used to automatically construct an operational navigation query to retrieve the desired information from one or more electronic network data sources, which is then transmitted to a client device of the user.

Zhou (Intel Corporation) (U.S. Pat. No. 6,999,932) discloses a language independent, voice based user interface method that includes receiving voice input data spoken by a user, identifying a language spoken by the user from the voice input data, converting the voice input data into a first text in the identified language by recognizing the user's speech in the voice input data based at least in part on the language identifier, parsing the first text to extract a keyword, and using the keyword as a command to an application.

Kennewick (VoiceBox Technologies Inc) (U.S. Pat. No. 7,398,209) discloses systems and methods for receiving natural language queries and/or commands and executing the queries and/or commands. The systems and methods operate through the application of a complete speech-based information query, retrieval, presentation and command environment. This environment makes significant use of context, prior information, domain knowledge, and user specific profile data to achieve a natural environment for one or more users making queries or commands in multiple domains. Through this integrated approach, a complete speech-based natural language query and response environment can be created. The systems and methods creates, stores and uses extensive personal profile information for each user, thereby improving the reliability of determining the context and presenting the expected results for a particular question or command.

These NLP systems operate at only a first level of interpretation. They allow a server and the like to take a spoken (or a written word) and to process it and to then search and find information related to it. If it is a specific command, then it acts on the command.

In particular, these NLP systems respond to “commands” or “statements.” What they cannot do is answer for a person. In other words, when a person hears or sees a statement or experiences or senses a physical action, the system would react and respond for him.

Therefore, there is also a need in the industry for an AI/NLP system that will respond on behalf of a person who hears or sees a statement or experiences or senses a physical action.

### BRIEF SUMMARY

These and other objects of the invention are achieved with a fast, efficient way to verify a person's identity so that information can be disclosed quickly, as well as a system that automatically generates an appropriate audio, written or physical response on behalf of a person who hears or sees a statement or experiences or senses a physical action.

Broadly stated, the invention involves a method of sending information about a user including: detecting a personal characteristic of a user; confirming an identity of the user by means of the physical characteristic; and sending a secure electronic transmission with information pertaining to the user.

According to the Invention, in its simplest, basic form, it involves detecting or scanning of a personal characteristic of a user and then verifying the person's identity by using this physical characteristic. If the identity is confirmed, then information is disclosed, as required.

In the preferred embodiment, the method of sending information about a user includes the steps of: an entity issuing an electronic identifier; detecting a personal characteristic of a user; confirming an identity of the user by means of the personal characteristic; and sending a secure electronic transmission relating to the electronic identifier to the entity with information pertaining to that user.

The instant disclosure is also directed to, in its simplest, basic form, automatically generating an appropriate audio, written or physical response on behalf of a person who hears or sees a statement or experiences or senses a physical action, based on that person's past behavioral pattern and experiences.

In one embodiment, the computer based method for assisting a user to respond to a statement or a physical act, includes the steps of: creating and continually updating a database of responses on behalf of the user to specific statements or physical acts from specified persons; entering details of a current statement or a physical act into a computing device, including information on an environment and an identity of the initiator of this statement or physical act; comparing details of the current statement or physical act to information in the database; and, based on information in the database, creating a response to the current statement or physical act.

Other objects, features and advantages of the present invention will become apparent upon reading the following detailed description in conjunction with the drawings and the claims.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a block diagram showing the method of the present disclosure.

FIG. 2 is a block diagram showing a second embodiment of the present disclosure.

### DETAILED DESCRIPTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

For purposes of the invention, the term electronic device includes any device that may be used for facilitating or effecting electronic communications, including, but not limited to, mobile devices, cell phones, smart phones, hand held computers, laptop computers, palm top computers, personal digital assistant (PDA), electronic pads and/or tablets, desk top computers, smart watches, smart cards, smart devices, digital cameras, televisions and monitors and screens, cloud computing sites, an Internet website, a portable device that may be used for electronic communication, security systems or any device generating or processing a natural language statement or any device processing, generating or storing data.

One common way to determine location is by determining a geographic location of an electronic device of a person. Typically determining a geographic location is done by “WIFI,” “Bluetooth,” “NFC,” “GPS,” GLONASS, mobile triangulation or similar technologies and applications. As described herein below, checking a physical location includes determining a physical location of an electronic device of a person by using one of these known protocols. Checking a physical location may also include determining a location of a person based on entries in an electronic calendar.

Broadly stated, the invention involves a method of sending information about a user including: detecting a personal characteristic of a user; confirming an identity of the user by means of the personal characteristic; and sending a secure electronic transmission with information pertaining to the user.

According to the Invention, in its simplest, basic form, it involves scanning, monitoring or detecting a personal characteristic of a user and then verifying the person's identity by means of that personal characteristic. If the identity is confirmed, then the information is disclosed, as required.

The object of the herein disclosed invention is to more quickly process and distribute information. One of the things that slows down dissemination of information is security. Before information can be disclosed, there is a need to verify identities.

By utilizing modern technology, the herein subject invention provides a fast and efficient way of verifying a person's identity.

The preliminary scanning/monitoring/detecting process may be accomplished by a person's electronic device, such as a smart phone, or by a scanner (or camera) on the premises of the relevant location. In some cases, a webcam may be utilized. Regarding the actual verification process, this can also be handled by a person's electronic device, such as a smart phone, or it may be handled by a server or security center.

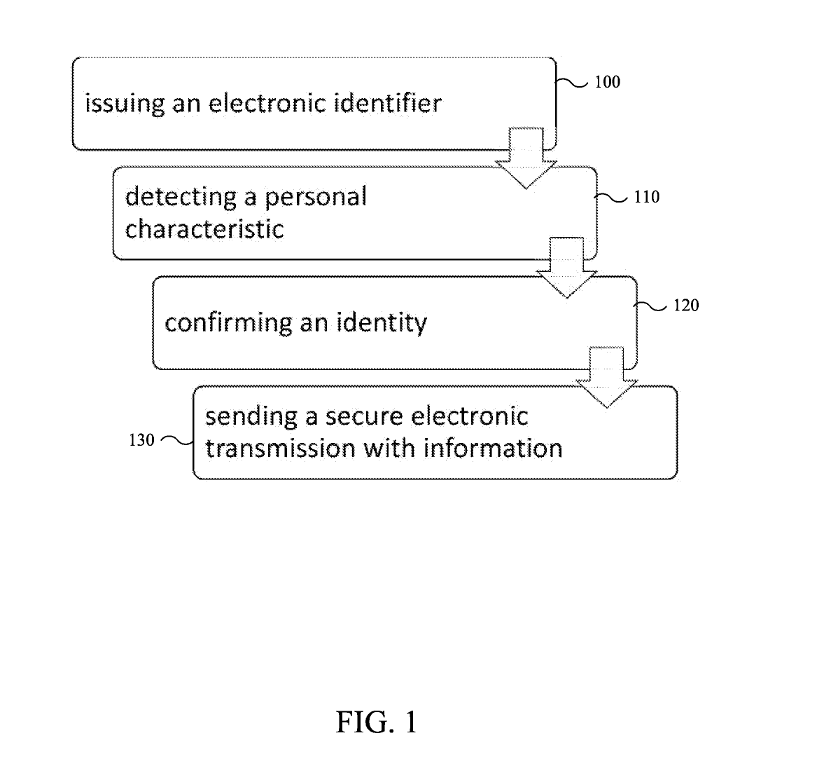

As shown in FIG. 1, in one embodiment, the method of sending information about a user includes the steps of: an entity issuing 100 an electronic identifier; detecting 110 a personal characteristic of a user; confirming 120 an identity of the user by means of the personal characteristic; and sending 130 a secure electronic transmission relating to the electronic identifier to the entity with information pertaining to that user.

It should be appreciated that the order of the steps in the method is not critical. Detecting the physical characteristic may be done before issuing the electronic identifier, for example.

The type of information that may be stored in a user's profile (the file of information) is unlimited. It may be simple biographic information, like phone, e-mail, address, birthday, and the like. Photos may be included. Audio and/or audio/video materials may be stored. For example, a user could store an audio/video film of a certain event—maybe a wedding or a birthday celebration. Graphics could be included. An artist might attach reproductions of their paintings. Financial information may be included, such as bank information or a government ID number. Travel preferences may also be included, like favorite airlines, frequent flyer member numbers, favorite hotels, preferred destinations and favorite time to travel. In addition, for security or other purposes, identification information may be included for purposes of verifying the person's identity. This may include personal characteristics of that person, such as inter alia, location, facial images, fingerprints, palm prints, voice patterns, iris images or behavior patterns. Moreover, the file may include identification numbers, passport information and government identification numbers and similar identification materials.

Further, the information pertaining to the user can include preferences. This can be useful in certain environments. For example, if the user is entering a hotel, once identity is verified, the information that is sent can include user preferences, such as wake up time, meals, movie section, type of room, and the like. It is even possible for the entity to be a person's own home. Here, once identity is verified, the transmitted information includes preferences, like temperature for heating/air condition, timing for lights, and the like. Another example may be where the entity is a travel company, like an airline. Once identity is verified, the airline receives with the information the flyer's preferences, like meals, movies, seat, and the like. Another example is you enter an office or a home, and it will identify you and set parameters and the environment according to your preferences in your profile, for things like temperature, music, lighting and so on.

In the preferred embodiment of the invention (again as referred to in FIG. 1), the first step is that an entity issues 100 an electronic identifier. The entity may literally be any private, public, business or government office or even an Internet website. Among the possible entities are, inter alia, service providers, health and medical facilities, professional service providers, government offices, utility companies, retail stores, Internet websites for financial and securities transactions, Internet websites for purchasing goods or services, Internet websites for storing data or information, software Applications, servers, networks, and any other operational location. Further, the entity may be a defined area or location, a building or a security zone.

For purposes of this herein invention, the entity issues some type of electronic identifier or marker. This electronic identifier identifies the entity and also the time, location and other pertinent data in order to identify the proposed interaction with the user. One type of electronic identifier could be a bar code. Another type may be an IP address. It may also be location coordinates, voice print, or any form of identification coordinates. The type of electronic identifier or marker is not pertinent to the herein invention. What is important is that there be some type of electronic identifier that identifies the entity and the proposed interaction with the user.

Another step involves scanning, monitoring and/or detecting 110 a personal characteristic of a user. Primarily this can be done in one of two ways. Either the entity is doing the detecting or the detecting is done by an electronic device of the user.

Personal characteristics of the user can involve anything that can be used to unambiguously identify a person. Hence, recognition scanning of a personal characteristic of a user may include, without limitation facial recognition, fingerprint or palm recognition, voice recognition, iris recognition or behavior recognition. A person's location may also be used as a physical characteristic in order to identify him.

Smart phones, for example, have developed to the point where they may include all types of hardware and/or Apps for scanning and identifying people. They can now record facial recognition scans and even finger prints and also medical and health parameters, like heart rate, pulse, blood pressure, and the like. Such technology is well known.

Furthermore, smart phone can detect a person's typing pattern and also a walking style or pattern. Even the way a person climbs or descends stairs can be indicative of his behavior and thus his identity. Therefore, these can be used to confirm a person's identity.

Therefore, the recognition scanning, monitoring or detecting can be affected by a personal electronic device of the user.

Furthermore, according to one embodiment, there can be continuous recognition scanning, monitoring or detecting of the user. This makes it possible for the system to determine if a person is no longer using his smart phones, such as, for example, if someone else picks it up. In that event, there would no longer be a verification of identity. Hence any authorized access or transmission of data would be ended or voided.

In another embodiment, the scanning, monitoring or detecting can be affected by scanners located at the entity. Such scanners may then be selected from the group comprising a camera, webcam, a microphone, a fingerprint reader, a facial recognition scanner, a palm scanner or an iris scanner, or any device for scanning a personal characteristic of a user.

Thereafter, there is the step of confirming 120 an identity of the user by means of the personal characteristic. In other words, the captured personal characteristic is used and compared against relevant data in a person's profile to make sure there is a match.

For example, if a fingerprint, or iris scan or a facial scan is collected, the system accesses the person's profile. In that profile, there are corresponding scans. If the scans match, then a person's identity is verified. This could be as simple as matching fingerprints, or iris scans or a facial scans. It may involve matching a behavior pattern. If a person types on the smart phone keyboard in a certain manner, was this same manner repeated and used? Walking, running or stair climbing patterns may also be compared.

Assuming identity is verified, then the system sends 130 a secure electronic transmission relating to the electronic identifier or marker to the entity with information pertaining to the user. By knowing not only the name of the entity but by also knowing the electronic identifier or marker, it is now possible to identify the proposed interaction and match up the secure information with the relevant user.

In some cases the secure transmission may send just the identification of the person as by name. This may be helpful in a security environment. Another example would that the Social Security Number is sent and may be applicable to a government office. When a bank is involved, account numbers may be utilized.

In some embodiments, the verification is done on the electronic device, such as the smart phone. Other embodiments envision it being done by a server or security center.

The method of sending 130 information about a user may further include: sending the electronic identifier to a secure server; sending the detected personal characteristic of the user to the secure server; the secure server confirming an identity of the user and identifying information relevant to the user; and the secure server sending the secure electronic transmission relating to the electronic identifier to the entity with information relevant to the user.

Similarly, the method of sending information about a user may further include: the electronic identifier being received by an electronic device of the user; the electronic device detecting the personal characteristic of the user; the electronic device confirming an identity of the user; and the electronic device sending the secure electronic transmission relating to the electronic identifier to the entity with information relevant to the user.

Another aspect is that the system may additionally establish a channel of electronic communication between the entity and the user. This could be, for example, e-mail, IM communications or a SKYPE session. In other words, the system can allow direct communication between the parties to facilitate the exchange of information and to facilitate transactions.

According to another aspect of the invention, the secure electronic transmission may be sent according to a predefined time schedule. In other words, instead of sending the transmission in real time, it may also or alternatively be sent at certain time intervals. For example, if a person frequents an establishment, the information might be sent only once a week or once a month and/or in real time.

As related hereinabove the transmitted secure information may be any pertinent data. In one embodiment it could be an electronic key. It may stay active for a predefined time, or may stay active for only as long as the smart phone verifies the user's identity. Such a key may be used for, inter alia, hotel rooms, health club lockers, or doors for secure facilities.

After being identified, there might be an option on the smart phone with a popup window asking for approval to link.

As mentioned, upon verification of identity, information about a person may be transmitted to a specified location. In particular, there is a profile with all of a person's information in the cloud or on a secure server or any universally available electronic location. It is irrelevant to the herein information as to who created the profile. It can be a self-created profile or by automatic gathering information or created by an interested entity.

The system verifies identity by means of, for example, facial recognition and/or fingerprint and/or voice recognition and/or iris recognition and/or behavior recognition and/or recognition of any other personal characteristic of a user. Your Smart Phone can obtain this information with built in hardware scanners and software. A third party can get the verified identity by installing a camera and/or a microphone and/or a fingerprint reader and/or an iris scanner and/or a scanner for any other type of personal characteristic of a user. All of the above gets routed back to the system and verified and verifies the identity of the user to the third party.

A Smart Phone can also act as verified smart ID. It keeps on verifying the identity of the user via camera and/or fingerprint and/or voice and/or any other detectable personal characteristic of a user. It sends the verified identification via the smart ID Smart Phone to a third party, as by any of the following protocols: picture/barcode and/or voiceprint and/or Bluetooth and/or NFC and/or WiFi and/or manually. There can be an option for manual approval by the profile owner before sending it to the third party.

All of the above can be sent instantly to the third party and/or they can be pulled for a selected time frame, like a list of check-ins. For example, an employer can see at the end of the month when an employee arrived and left work.

Some embodiments may provide for the third party to get a notification whenever someone is sending him his verified identification.

An alternate embodiment may provide that, whenever a verified identification is sent to a third party, a communication link is established between the profile owner and the third party.

In some embodiments, instead of getting an entity ID/marker via scanning, it is done via location. For example, when you get next to the office or in the office, the system does all the verifications and notifying the entity that you are in the office so they reply back to you with a key to be used locally via your smart phone via Bluetooth or NFC or WiFi to access, for example, opening doors, accessing servers, and the like. Moreover, the system may be used for a work time check. Using a combination with identity verification plus location, you can check in at work or it will be done automatically when the system verifies your identity plus your location.

There is also the ability to use this invention for security zones. When a person is recognized, the secure transmission my reveal his identity. If the person is not supposed to be there, the appropriate authorities may be contacted.

Moreover, the entity can designate a recipient of the secure electronic transmission. In other words, the entity may decide that the information may go to a certain person or organization. Sometimes the alert could be to the police or government.

Another variant is the system may filter to identify or not identify only certain predefined persons.

This may be especially useful in security zones. For example, if such persons are identified, security may be notified because they are not supposed to be in that security zone.

According to another embodiment, the system may be used for entering secure websites, applications, and/or software. Generally to enter secure websites, you need to enter a user name and password. Typically this includes bank and financial websites. It may also include shopping websites, such as Amazon. Instead of being bothered with entering the data, this system may be used. This also provides the advantage of verifying identity, since usernames and passwords can frequently be stolen or misused.

In this embodiment, the entity includes a secure electronic location for interactive activity pertaining to financial or banking activity, or purchasing or selling goods, services, securities or financial products, or confidential personal or business information, or any secure website, software or application. Basically it can be any website or secure location that generally requires a user name and/or password for entry.

Therefore, in this embodiment, interactive activity with the secure electronic location being effected without entry of a user name or password.

According to this embodiment of the Invention, a method of facilitating a user to enter a secure electronic location includes: identifying an electronic location for interactive activity; the electronic location issuing an electronic identifier; an electronic device of the user receiving the electronic identifier; the electronic device confirming an identity of the user; and a secure electronic transmission relating to the electronic identifier being sent to the proprietor of the electronic location with information pertaining to the user.

The first step is that the user has to in some manner identify the secure location, such as the website, application, or software. Typically this may be accessing the Internet website on his Smart Phone. The website then issues an electronic marker for this proposed interaction. In some cases it may be a bar code. The Smart Phone, or other electronic device, scans and records that electronic marker. Then, as described hereinabove, the Smart Phone, or other electronic device, confirms identity. This can be by scanning personal characteristic of a user and matching it with image in the user's profile. Once the verification is completed, any necessary information in the user profile is sent to the entity. The electronic marker is referenced, so the entity, like Amazon, can match the user and data to the proposed interaction session.

The electronic location may be selected from the group comprising Internet websites for financial and securities transactions, Internet websites for purchasing goods or services, Internet websites for storing data or information, kiosks, point of sale devices, webcams, software, applications, servers, networks, service providers, health and medical facilities, professional service providers, government offices, utility companies, retail stores and any other interactive locations.

In one embodiment, the electronic marker is a bar code, and the electronic device includes a bar code scanner.

Further, according to this embodiment, confirming an identity of the user includes recognition scanning of a personal characteristic of the user. The recognition scanning may include scanning of facial images, video, audio or mixed media, photographs, finger prints, palm prints, Iris/Eye prints, and/or behavioral patterns. In addition, confirming an identity of the user includes matching the recognition scanning of a personal characteristic of the user with information contained in a profile pertaining to the user.

According to still another embodiment, the method further includes monitoring a physical location of the user; comparing the physical location of the user to a location of the physical characteristic of the user; and, when the physical location of the user and the location of the physical characteristic of the user do not coincide, sending a new secure electronic transmission relating to the electronic identifier to the entity to advise that the identity of the user is no longer confirmed.

In particular, the location of the user is continually monitored, as described hereinabove. Further the system knows the location at which the physical characteristic is being taken, since location is one of the attributes of the physical characteristic and of the entity. Therefore if the person is not at that location, the system knows there is something wrong and sends a transmission to say the verification of the user is no longer confirmed. For example, the user may be traveling in London, as confirmed by the monitoring of his location. If the system now gets a characteristic check for the same time, but in New York, then obviously it cannot be the same person. Therefore, the system has a means to detect fraud if someone is trying to use someone's identity and/or has stolen his smart phone.

In a secondary embodiment, the Invention, in its simplest, basic form, involves automatically generating an appropriate audio, written or physical response on behalf of a person who hears or sees a statement or experiences or senses a physical action, based on that person's past behavioral pattern and experiences.

What the system does is replicate a person's response. If a person would respond to a situation orally (audio) or in writing, so does the system. In a case where the response would be an action, like opening a door or adjusting a thermostat, the system would affect such action. The system, in other words, is like your personal assistant, albeit in an electronic format.

For example, a person is sitting at his desk and Joe walks into the office. Based on a review of the database for past interactions with Joe in an office setting, the system knows you always ask Joe if he wants coffee. So, the system automatically asks Joe if he wants coffee. If you instead met Joe on the street at lunchtime, the system knows from prior interactions with Joe at lunch hour on the street that you always ask him to come along for lunch. Thus, the system automatically asks Joe that question—do you want to come along for lunch.

On the other hand if a stranger walks into your office, the protocol is different. From past interactions with strangers, the system knows you say hello and then ask who he is and what does he want, or words to that effect. So, the system automatically does the same thing and asks the same questions.

When searching the database of past interactions, the system is looking not just for interactions with that same person (or category of person), but also for the same type of environment or circumstances. People generally react to the same person differently, depending on the location and circumstances. If you meet your employer in the office, you act differently than if you meet him at a sporting event or at the movies. This is why the system needs to evaluate not just past responses to this person, but specifically responses under these same types of circumstances. Responding the way you would in the street is of no value if you are meeting the person in a business environment.

Further, it should be appreciated that the system does not always generate responses that are the same as ones used previously. What it is doing is analyzing the current information and, based on information in the database, generating an appropriate response. Sometimes the response may be the same as one previously used, but other times the response may be modified or wholly new in order to fit the current circumstances.

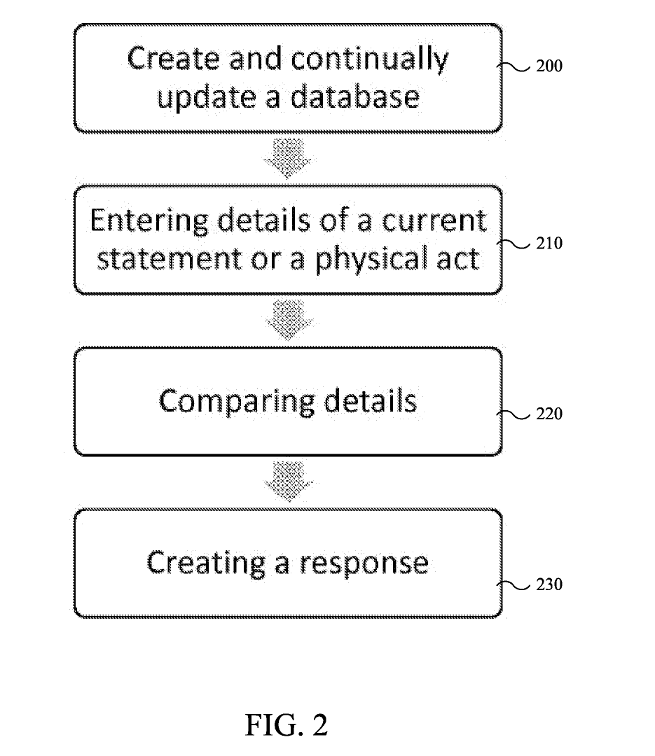

As show in FIG. 2, the computer based method for assisting a user to respond to a statement or a physical act includes the steps of: creating and continually updating 200 a database of responses on behalf of the user to specific statements or physical acts from specified persons; entering 210 details of a current statement or a physical act into a computing device, including information on an environment and an identity of the initiator of this statement or physical act; comparing 220 details of the current statement or physical act to information in the database; and, based on information in the database, creating 230 a response to the current statement or physical act.

As a necessary preliminary process, the system must maintain a database of responses of and on behalf of the user to specific statements or physical acts from specified persons. Included in the database for every response is a full set of details, including, but not limited to, date, day, time, location, environment, weather, circumstances, statements and actions of initiator, audio, written and physical acts and statements and any other pertinent details, as well as the actual response. This then becomes the table of reference. Each time a situation arises, the system looks through the database to locate previous analogous situations. Sometimes, there may be exact matches, but other times only partial matches. In these latter cases, the system comes as close as it can. Even if there is an exact match to a prior interaction, there may be a reason to modify the current response.

Further, there may be times when the system relies on current data or outside data.

One important aspect is that after a response is done, that response and all the details concerning that interaction are added to the database. In this manner the database continuously grows and expands. Thus, in the future the database will have more and more reference items from which to generate a suitable response. Therefore, the response to the current statement or physical act for the user is added to the database.

According to one embodiment, the response to the current statement or physical act for the user is done automatically. Typically this means without active participation by the user. It is also possible for the response to be semi-automatic or even manual. Sometimes the user may, for whatever reason, want to override and not use the system generated response. Therefore, the user can modify, reject or accept the response to the current statement or physical act. This may be especially important if the current situation does not have an exact or even a similar match on the database.

More particularly, the system may be set to automatically answer; but, when it has some uncertainty, it might ask or notify the user with a suggestion to approve. Other times when there is uncertainty, the system could have no suggestion and the user has to respond manually.

Further, there can be sentence completion if the user starts typing. For example, the user ignores the suggested response or none is suggested. The user will start typing and the system will auto suggest or auto complete the whole sentence, based on the partial sentence and based on the user's past behavior patterns, experiences and responses.

Once the initiator comes into the presence of the user, the system enters details of a current statement or a physical act into a computing device, including information on an environment and an identity of the initiator of the statement or physical act. In other words, all the pertinent details of the interaction must be collected and entered into the system. Without this data, the system does not know to what it has to respond.

According to a preferred embodiment, entering details of a current statement or a physical act into a computing device, including information on an environment and an identity of the initiator of the statement or physical act, includes detecting a personal characteristic of the initiator. Essentially this means scanning or detecting some feature of the initiator and using it to identify the person.

The personal characteristic of the user may include, inter alia, location, facial images, fingerprints, palm prints, voice patterns, iris images or behavior patterns. Detecting a personal characteristic of the initiator includes comparing the detected personal characteristic of the initiator with information contained in a profile pertaining to the initiator.

In one embodiment, the scanning/monitoring/detecting process may be accomplished by a person's computing device, such as a smart phone, or by a scanner (or camera) on the premises of the relevant location. In some cases, a webcam may be utilized. Regarding the actual identification process, this can also be handled by the person's computing device, such as a smart phone, or it may be handled by a server or security center or a desk top computer.

The step of scanning, monitoring and/or detecting a personal characteristic of a person primarily can be done in one of two ways. Either the physical location itself has equipment for doing the detecting or the detecting is done by a computing device of the user.

Personal characteristics of the user can involve anything that can be used to unambiguously identify a person. Hence, recognition scanning of a personal characteristic of a user may include, without limitation facial recognition, fingerprint or palm recognition, voice recognition, iris recognition or behavior recognition. A person's location may also be used as a physical characteristic in order to identify him.

Smart phones, for example, have developed to the point where they may include all types of hardware and/or applications for scanning and identifying people. They can now record facial recognition scans and even finger prints and also medical and health parameters, like heart rate, pulse, blood pressure, and the like. Such technology is well known.

Furthermore, smart phone can detect a person's typing pattern and also a walking style or pattern. Even the way a person climbs or descends stairs can be indicative of his behavior and thus his identity. Therefore, these can be used to confirm a person's identity.

Therefore, the recognition scanning, monitoring or detecting of the physical characteristic of the initiator can be affected by a computing device of the user.

In another embodiment, the scanning, monitoring or detecting can be affected by scanners located at the physical location, like the office. Such scanners may then be selected from the group comprising a camera, webcam, a microphone, a fingerprint reader, a facial recognition scanner, a palm scanner or an iris scanner, or any device for scanning a personal characteristic of a person.

According to another embodiment, entering details of a current statement or a physical act into a computing device, including information on an environment and an identity of the initiator of the statement or physical act, includes obtaining details from an electronic calendar. In this situation, the system reverts to an electronic calendar, which contains full details of all meetings, including day, date, time, location, participants and subject matter. By accessing the electronic calendar, the system knows who the initiator must necessarily be, based on day, date, time, and location. Then by analyzing the circumstances, including the subject matter of the meeting, the system knows what to reference in the database.

In still another embodiment, entering details of a current statement or a physical act into a computing device, including information on an environment and an identity of the initiator of the statement or physical act, includes monitoring a physical location of the initiator; comparing the physical location of the initiator to a location of the user; and, when the physical location of the initiator and the location of the user coincide, identifying the initiator as a person to whom the response should be directed. According to this procedure, people are continuously monitored so that their locations are known. This can be done by GPS-type protocols or similar technologies, as mentioned above. In this way, since locations are monitored, the system can easily detect and identify the person who just entered into the physical area of the user.

Further, entering details of a current statement or a physical act into a computing device includes information on an environment. This can sometimes be important. People interact differently in different settings. Environment can include a myriad of things. For example, it typically includes location. Such information can be obtained from GPS-type protocols or simply from electronic calendars. Information on weather (if the meeting is outdoors) is obtainable by standard weather sensor devices in portable devices, like smart phones. It is also possible to enter such data manually.

In a preferred embodiment, the current statement can be text, audio or visual, media, or a combination; and, the past responses on behalf of the user and the response to the current statement or physical act being audio or written statements or physical actions or electronic actions.

What this means is that the system can reply to spoken words or to physical actions. As described hereinabove, NLP systems interpret spoken and written words. Such systems would work here. When the initiator enters and speaks (or writes something), the system takes those words in (audio or written) and interprets them. Based on the meaning and the environment and past examples in the database, a response is created.

In some cases it is not words, but actions. The person opens a door, sits in a chair, extends his hand, gestures with his face, or makes any of countless other actions or movements. Standard sensors, like cameras or other monitors, can record these activities. Once the action is recorded, it can now be analyzed, just like the spoken word is analyzed.

The response may also be physical. For example, a door may be opened, a coffee maker can be activated, or the thermostat can be adjusted. The list is endless. It should be appreciated that physical acts include electronic acts, like entering a website or an application or activating software.

Now that the system has the current statement—whether it is spoken, written or physical—it compares details of the current statement or physical act to information in the database. In other words, it refers to the database to find the most relevant prior interactions. It should be appreciated that such database searches, with today's technology, take fractions of a second, so there is no appreciable or discernible delay in formulating the response.

At this point, based on information in the database, the system creates a response to the current statement or physical act. In some cases, the system may attach files or documents to the response.

Therefore, this is a system that automatically generates an appropriate audio, written or physical response on behalf of the user to the current statement or a physical act, based on past behavioral patterns and experiences of the user.

As explained, in order to be most relevant, the system relies on past interactions with that same initiator under the same type of conditions and circumstance, or as close as can be found.

The system, for example, may also be used if someone shows up in your office. Then the system will welcome the person and initiate a conversation. It can then also answer the person. In certain circumstances the system will auto initiate a conversation with a particular person, based on his past and profile.

It will be appreciated that the response or conversation initiation is based on the past behavior of you and that person; and, so on, for each person, the initiation of a conversation or response to same incident might be different.

Further, since the statements can be text, audio or visual, media, or a combination, this system will also work for forms—auto fill-in. It will be able to auto fill a form by understanding the questions.

In particular, the form would be entered like any other written statement. Then the system would parse it question by question and make responses, based on the person's past behavior and history. Hence, the current statement can be a form and the response includes completion of the form.

For example, as described above, the system might detect someone by object recognition, and start a conversation by voice or text. “Hello and welcome to my office. What is your name . . . ” “How may I help you”? If the system recognizes the person by facial recognition, it can start a personal conversation with him.

Similarly, if a person is at Macy's and you are also there. According to past behavior patterns, the system might automatically send you a message “Hi Moshe, How are you?” “I am also here”.

The list of practical applications is endless. In instances where a person usually initiates conversations, the system will do it automatically.

According to another embodiment, the system may be monitoring the user and, based on his current circumstances and past behavioral patterns, certain statements or actions should ideally be initiated. A computer based method for generating a statement or an action on behalf of a user, includes the steps of: creating and continually updating a database of statements and actions by or on behalf of a user in connection with specified locations, environments, times or actions; continually monitoring current location, time, environment or activity of the user; comparing details of current location, time, environment or activity of the user to information in the database; and based on information in the database, creating a statement or action on behalf of the user.

This embodiment involves continually monitoring a person, including his location and circumstances. For example, a person is driving in his car. Due to monitoring and past behavioral patterns, the system knows he will be late to get home. Therefore, it automatically sends an electronic message to his wife (for example e-mail or instant message) to tell her he is running late. The message could mention his location and/or the circumstances.

Another example would be a person walks into an office or a home. Here too based on past behavioral patterns, the system knows he sets the thermostat for 19° C. Therefore, the system automatically sets the thermostat. It could instead be starting a coffee maker or turning on computers or office equipment.

The statement on behalf of the user may include information about the location, time, environment or activity of the user.

In addition to location, the system is monitoring what the person is doing. Is he driving in his car, riding on a bus, working on his computer or any of a myriad of other possible activities? What is the environment—is he in the office or at home or in a park?

This embodiment involves the same basic process. The current situation is examined and compared to past behavioral patterns. Then, based on the past behavioral patterns, an appropriate statement or action is generated. Its other aspects are the same as the embodiment described hereinabove.

As mentioned hereinabove, the system may be used for auto completion of statements. The computer based method for assisting a user to respond to a statement, includes the steps of: creating and continually updating a database of responses on behalf of the user to specific statements from specified persons; receiving an electronic communication; entering details of the electronic communication into a computing device; comparing details of the electronic communication to information in the database; and, based on information in the database, creating at least a partial response to the electronic communication. In a preferred embodiment, the electronic communication may be selected from the group comprising e-mail, instant messages, twitter communications, telephone, video conferencing and person to person audio, video and media communications. In some cases, information on subject matter and the identity of the initiator/sender of the electronic communication is also provided to the system. Basically it means that is some cases, comparing details of the electronic communication to information in the database includes information on subject matter or the identity of a sender of the electronic communication.

For example, if someone sends you a text message, the system may generate, suggest or auto finish a response sentence based on past behavioral patterns or experiences.

Again it relies on the same basic principles. Some type of audio, visual, media, written, mixed media statement (or document) is received. Based on the prior information in the database, an appropriate response is generated or at least a partial response. Here too the user may modify, accept or reject the response or partial response. Its other aspects are the same as the embodiment described hereinabove.

In this type of scenario, some type of statement is received. The system then attempts to complete the statement.

Still another embodiment involves a multi-person conversation. The system acts for at least one of the participants. One person makes a statement. Based on past behavioral patterns, the system generates a response for the other person, which can be modified, accepted or rejected by him. Then, as in a regular conversation, it reverses. Now the person making the first system has to respond, and so on and so forth.

This computer based method for assisting a user to participate in an electronic conversation, includes the steps of: creating and continually updating a database of past behavioral patterns and experiences of the user and of electronic conversations involving this user; comparing details of at least one current statement of an opposing participant in the electronic conversation to information in the database; and, based on information in the database, creating at least one partial or complete statement for the electronic conversation on behalf of the user. In some cases the details of the current electronic conversation may include information on subject matter and an identity of the opposing participant of the electronic conversation. In a preferred embodiment, the electronic communication may be selected from the group comprising e-mail, instant messages, twitter communications, telephone, video conferencing and person to person audio, video and media communications.

Auto-filling of forms is contemplated by another embodiment. The principle is the same. A document is received and compared to the database. In this case the document happens to be a form. Then, based on form content and information in the database, the form is completed or information for completion of the form is generated, based on information in the database.

This computer based method for automatically completing forms on behalf of a user, includes the steps of: creating and continually updating a database of information pertaining to the user, including specific statements and physical actions in response to specific statements from specified persons and prior utilized completed and semi-completed forms; receiving an electronic communication containing a form or information for completion of a form; parsing the form or information for completion of a form to identify information for completion or semi-completion of the form; comparing details of the electronic communication and the form and the information for completion or semi-completion of the form to information in the database; and, based on information in the database, at least partially completing the form or providing information for at least partially completing the form. In some cases, the information for completion of a form might be the fields of the form or similar information.

In short summary, the system can generate a message based on the current situation (either a response or just a message). It may also generate a specific physical or electronic act based on the current situation. This is all based on past behavioral patterns and experiences and on past responses.

One or more embodiments of the present invention have been described. Nevertheless, it will be understood that various modifications may be made without departing from the spirit and scope of the invention. Accordingly, other embodiments are within the scope of the following claims.

What is claimed is:

1. A method of sending information about a user comprising the steps of:
an entity issuing an electronic identifier;
detecting a personal characteristic of a user;
confirming an identity of said user by means of said personal characteristic; and
sending a secure electronic transmission relating to said electronic identifier to said entity with information pertaining to said user.

2. The method according to claim 1, wherein said personal characteristic of said user includes location, facial images, fingerprints, palm prints, voice patterns, iris images or behavior patterns.

3. The method according to claim 1, wherein said detecting said personal characteristic of said user is done continuously.

4. The method according to claim 1, further comprising sending a new secure electronic transmission relating to said electronic identifier to said entity when said physical characteristic changes or when a physical characteristic can no longer be detected.

5. The method according to claim 1, further comprising sending a new secure electronic transmission relating to said electronic identifier to said entity when a location of said user changes.

6. The method according to said claim 1, wherein confirming an identity of said user includes comparing said detected personal characteristic of said user with information contained in a profile pertaining to said user.

7. The method according to claim 1, further comprising establishing a communication channel between said entity and said user.

8. The method according to claim 1, wherein said detecting being effected by scanners is located at said entity.

9. The method according to claim 8, said scanners being selected from the group comprising a camera, webcam, a microphone, a fingerprint reader, a facial recognition scanner, a palm scanner, an iris scanner or a device for scanning a personal characteristic of a user.

10. The method according to claim 1, wherein said detecting being effected is by an electronic device of said user.

11. The method according to claim 1, wherein said sending said secure electronic transmission is according to a predefined time schedule.

12. The method according to claim 1, further comprising said entity designating a recipient of said secure electronic transmission.

13. The method according to claim 1, further comprising filtering to identify or not identify only certain predefined persons.

14. The method according to claim 1 further comprising: monitoring a physical location of said user; comparing said physical location of said user to a location of said physical characteristic of said user; and, when said physical location of said user and said location of said physical characteristic of said user do not coincide, sending a new secure electronic transmission relating to said electronic identifier to said entity to advise that said identity of said user is no longer confirmed.

15. A secure method of supplying an electronic key to a user comprising the steps of:
detecting a personal characteristic of a user;
confirming an identity of said user by means of said personal characteristic; and
sending a secure electronic transmission with an electronic key to said user.

16. A computer based method for assisting a user to respond to a statement or a physical act, comprising the steps of:
creating and continually updating a database of responses on behalf of said user to specific statements or physical acts from specified persons;
entering details of a current statement or a physical act into a computing device, including information on an environment and an identity of the initiator of said statement or physical act;
comparing details of said current statement or physical act to information in said database; and
based on information in said database, creating a response to said current statement or physical act.

17. The computer based method according to claim 16, wherein said entering details of a current statement or a physical act into a computing device, including information on an environment and an identity of the initiator of said statement or physical act, includes detecting a personal characteristic of said initiator.

18. The computer based method according to said claim 17, wherein detecting a personal characteristic of said initiator includes comparing said detected personal characteristic of said initiator with information contained in a profile pertaining to said initiator.

19. The computer based method according to claim 16, wherein said entering details of a current statement or a physical act into a computing device, including information on an environment and an identity of the initiator of said statement or physical act, includes obtaining said details from an electronic calendar.

20. The computer based method according to claim 16, wherein said entering details of a current statement or a physical act into a computing device, including information on an environment and an identity of the initiator of said statement or physical act, includes monitoring a physical location of said initiator; comparing said physical location of said initiator to a location of said user; and, when said physical location of said initiator and said location of said user coincide, identifying said initiator as a person to whom said response should be directed.
